(19) United States
(12) Patent Application Publication
(10) Pub. No.: US 2017/0184232 A1
(43) Pub. Date: Jun. 29, 2017

(54) Method For Connecting A Coupling Device To Respective Ends Of Two Pipes, And Structure Of Said Coupling Device

(71) Applicant: ODIN CONNECT AS, Bergen (NO)

(72) Inventor: Rune Langhelle, Bergen (NO)

(21) Appl. No.: 15/300,196

(22) PCT Filed: Apr. 8, 2015
(86) PCT No.: PCT/NO2015/050062

§ 371 Date: Sep. 28, 2016

(30) Foreign Application Priority Data
Apr. 8, 2014 (NO) 20140458

(51) Int. Cl. F16L 23/028

(52) U.S. Cl. CPC F16L 23/0286

(57) ABSTRACT

A method is described for fastening coupling means to respective ends (25,26) of pipes (10, 12) that are to be joined together, comprising a pair of mutually axially telescopic conical casings (18,22) that are inserted, one on each pipe end, as the conical casing pair are mutually pushed together with the help of respective tightening bodies (14, 16) so that the radially outer casing (18) squeezes the inner casing (22) into a fastening against the surface of the pipe (10, 12) and joins the pipe ends together, so that a tight joining together is achieved between the ends (25,26) of the pipes (10, 12) and it is characterised in that an inner conical casing (22) is used which is divided into a number of sections of axially directed slits (30) through the wall of the casing, said slits (30) contribute to the inner casing being able to be forced radially inwards during the simultaneous closing of the slits (30) and so that the inside of the inner conical casing is forced into a fastening against the surface of the pipe during the mutual pushing together of the casings. A coupling construction and an application of this are also described.

The present invention relates to a method to fasten coupling devices to respective ends of pipes that shall be joined together, comprising a pair of mutually axially conical casings that can be telescopically collapsed into each other and which are inserted onto separate pipe ends, as the conical pair of casings are mutually pushed together with the help of respective tightening bodies so that the radially outer casing squeezes the inner casing into a fastening against the surface of the pipe and joins together the pipe ends so that a tight coupling together of the pipe ends is achieved.

The invention also relates to a construction for the coupling together of pipes, i.e. two pipes that are placed end-to-end, and without there being a need for welding or gluing them together. In particular, it relates to the coupling together of metallic pipes, but it can also be used on other types of pipes such as plastic pipes.

### PRIOR ART

When two pipes shall be coupled together in that adjoining pipe ends are placed end-to-end, it must take place in such a way that no leaks arise in the joint so that liquid or gas, which the pipe later is to conduct, does not leak out through the joint.

Today, there are so-called cold, weld-free solutions to couple together pipes without the use of heat (welding/soldering), and as a rule this involves the use of a flange. The methods that dominate the market are based on the pipes being processed and pre-treated to secure them together with the help of a flange, i.e. a flange on each pipe end, and then the pipe ends are placed against each other with a gasket placed in between. A number of axially directed threaded bolts are inserted through the two ring-formed flanges that are arranged on each side of the coupling, and by a tightening of the nuts on the bolts, the pipe ends are screwed towards each other so that the gasket closes the opening between the pipes completely and gives a tight seal. However, this leads to a need to use complex machinery, often large and heavy machinery for the coupling to retain its position on the tubes.

A series of such joints are previously known where one uses seals of an elastic material, such as plastic or rubber, which are squeezed together around the joint between the pipes with the help of conical pipe casings that are screwed together.

Of the previously known devices reference is given to British patent GB-502.386 and Chinese utility model CN-2303989.

Said British patent GB-502.386 describes a construction to seal the gap between two pipe sections that are placed end-to-end, to carry a fluid, gas/liquid through the pipes.

A short casing is threaded in over and covers and envelops the gap between the pipe ends, whereafter ring-formed flanges threaded over respective pipe ends in advance and the pipe ends are brought forward to lie against their associated ends of the casing that covers the joint.

When two ring-formed flanges 4, which comprise correspondingly formed conical inner surfaces, are screwed towards each other and together, the flange cone will force together the gaskets so that they are deformed and generate a grip against the pipe surface at their ends which are thereby held tightly together.

The Chinese utility model CN-2303989 suggests joining together the pipe ends with the help of radially running screw bolts 7 and 3, respectively, and two facing ring flanges 6 and 3, respectively, that are brought towards each other and over a loose casing 8 that is placed enveloping the pipe ends. The flanges are screwed together by axially running bolts 1 and the pipe ends are held against each other with a contribution from the radial screw bolts through the flanges.

Also known are a series of variants around the basic principle of wedge-formed gaskets and casings to create a tight coupling. For example, reference is given to the following publications: TW 201043823, US-2005146139, U.S. Pat. No. 3,284,112 and BE-719.064.

Common to all these known solutions is that the casing-formed gasket element that lies innermost covers the gap between the pipes, and that there is no separate gasket between the pipe ends that shall lie end-to-end. Furthermore, each end of the gasket casing is cut at an angle to be squeezed together between/below correspondingly cut elements (ring-formed flanges) and which are, in advance, threaded onto the pipes and which now are led back and in over the gasket casing and squeeze this together by the screwing of, for example, axially running bolts.

### AIM OF THE INVENTION

With the present invention one aims to provide a solution where each pipe end comprises its own coupling body, and thus does not cover the gap, as the coupling body comprises, in itself known, correspondingly formed wedge shapes that shall by mutual axial displacement towards each other, come into a position of being squeezed against the pipe.

It is a further aim of the invention to be able to couple together pipes without the need to pre-treat the pipe surfaces.

Furthermore, it is an aim of the invention to provide a construction where the only function of each coupling body is to couple together the pipes, while a ring gasket performs the sealing function itself.

Furthermore, it is an aim of the invention to provide a seal between the pipe ends in the form of a flexible gasket ring with circumferential dimensions adapted to the diameter and wall thickness of the pipe.

Furthermore, it is an aim of the invention to provide a solution where one gets a tight pipe joining without the ring gasket between the pipes, when one applies another pulling together method by the use of a flange nut without bolts.

Thus, one aims to provide a new construction for this pipe coupling.

The method according to the invention is characterised in that a respective inner conical casing is used which is divided into a number of sections by axially directed slits through the casing wall, said slits contribute to the inner casing being able to be forced radially inwards with a simultaneous closing of the slits so that the inside of the inner conical casing is forced into a fastening against the pipe surface during the mutual pushing together of the casings.

According to a preferred embodiment, the respective tightening bodies, one on each side of the rear sides of the pair of casings, are led towards each other and fasten the coupling means to respective pipe ends, and also join the pipe ends together.

It is preferred to bring the ends of the pipes to force together an in-between lying ring gasket to generate a secure seal.

According to a preferred embodiment, an inner conical casing is applied, the inner side of which comprises means such as sharp-edged grooves, cams or spikes that are squeezed against and into the pipe surface in the pushing together operation and fasten the pair of casings to the pipe.

According to a preferred embodiment, an inner casing is applied that is divided into four casing sections via a corresponding number of slits, as the sections are held together as a complete casing in that a joining agent, such as a glue material, is added to adjoining edges facing the slits, or that the slits do not cut completely through the whole of the wall thickness of the casing so that the section is held together via a thinner, deformable remaining wall part of the casing.

According to a preferred embodiment, the ring-formed flange edge (front side of) on the front end of the outer casing squeezes against a correspondingly formed ring flange edge (rear side of) on the front end of the inner casing, as the respective tightening bodies are made to lie against said flange edges of the respective outer casings to bring the pipes together.

Particularly preferred is that an inner casing of a metal, such as stainless steel or titanium, or a material of a plastic material, fibre-reinforced plastic material or a composite material containing carbon fibres, such as an epoxy based carbon fibre-reinforced material, is used.

### THE PRESENT INVENTION

The construction according to the invention is characterised in that the inner conical casing is divided into a number of sections by axially directed slits through the casing wall, said slits contribute to the inner casing being able to be forced radially inwards with a simultaneous closing of the slits, and so that the inside of the inner conical casing is forced into a fastening against the pipe surface during the mutual pushing together of the casings.

It is preferred that the separate sections by the axially directed slits through the casing wall are held together as a compete casing in that a fastening agent is added, such as a glue material, in the adjoining edge surfaces facing the slits, or that the slits do not cut through the whole of the casing wall thickness so that the sections are held together via a thinner, remaining wall part of the casing.

In particular it is preferred that the inner surface of the inner conical casing comprises fastening means in the form of sharp-edged grooves, cams or spikes, set up to be squeezed into the pipe surface.

According to a preferred embodiment, the inner surface of the casing comprises a sealing layer and also said sharp-edged grooves, cams or spikes, as the sealing layer can be brought to squeeze against the pipe surface at the same time as the sharp-edged grooves, cams or spikes are forced into the pipe.

According to yet another preferred embodiment, the casing is divided into four casing sections via a corresponding number of slits held together by a fastening means.

According to yet another preferred embodiment, the respective front ends of the casings comprise flange edges that are brought to lie against each other when the casings are pushed together to be fastened to the end of the pipe.

According to yet another preferred embodiment, the inner casing applied is of metal, such as stainless steel or titanium, or a plastic material, or a composite material containing carbon fibres, such as an epoxy based carbon fibre reinforced material.

According to the invention, a construction is used to couple together two pipes as each pipe end comprises said construction, where respective tightening bodies are brought together against the rear side of their separate construction, and the tightening bodies are squeezed against each other so that the coupling constructions are fastened to respective pipe ends surfaces and furthermore, a tight coupling together is achieved between the ends of the pipes.

Thus, none of the known solutions show a solution where split casings or two or more angle-formed conical parts (trapezium formed) are brought over the pipe joint by two facing pipe ends, and where a corresponding conical casing is threaded onto each split casing from either side. The angle-formed parts have the same inner angle as the pipes and a small angle, i.e. a small increase in material thickness from low at the outermost to greater at the innermost.

### DESCRIPTION OF THE FIGURES

The invention shall be described in more detail in the following, with reference to the enclosed figures, in which:

FIG. 1 shows an expanded outline of a perspective of the invention and shows all the parts of the constructive construction of the coupling bodies 18,22 related to two pipes 10,12 that shall be coupled together.

FIG. 2 shows a cross section of the joined together pipes. The figure also shows a ring gasket 32 that can be inserted between the pipe ends to form an extra secure seal between the pipe ends.

FIG. 3 shows a cross section of the assembly of pipe 12 and the enveloping divided coupling casing soon after it is mounted onto the pipe end. A number of glue points to hold them together are also shown schematically.

FIG. 4 shows the assembly after the clamping casing 18 is forced onto the coupling sections so that these are squeezed together around the pipe 12.

FIG. 5 shows a perspective of the coupling casing to show the dividing slit 30 and also a band 50 that is wrapped around to hold the parts together.

FIG. 6 shows a longitudinally running perspective outline of the joined together pipes.

FIG. 7 shows an alternative where the pipes with the inserted new coupling construction 18,22 are coupled together with the help of threaded casings 40, 42 which are individually, from either side, screwed in onto a common casing-formed intermediate piece 50 which, at the same time, comprises a sealing-ring flange to lie between the pipe ends in a screwed together position.

### DESCRIPTION OF PREFERRED EMBODIMENTS

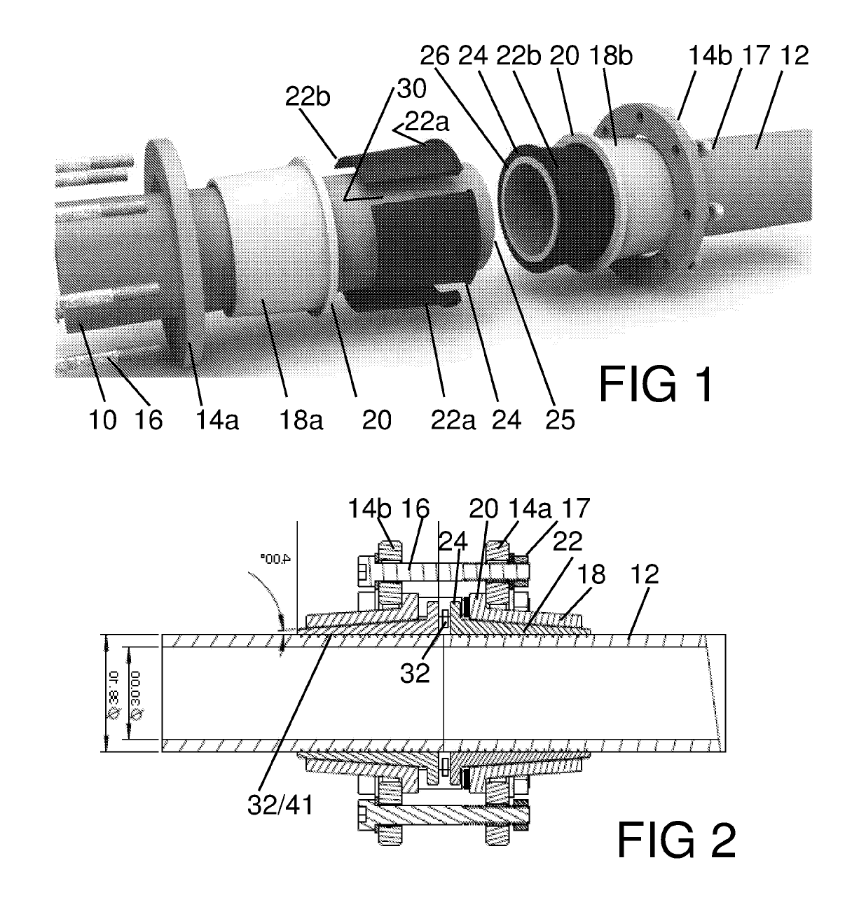

Firstly, the invention shall be explained in connection with FIGS. 1 and 2.

Thus, there are two pipes, 10 and 12, respectively, that shall be coupled together end to end, and the invention shall be described with the tube 10 at the left of the figure as a starting point, as there are the same elements which are coupled to the second tube 12, before the two pipes are completely coupled together.

A coupling casing 22 is first threaded in over the end 25 of the pipe 10. This coupling casing makes up the central element of the invention and is of a material of metal such as steel, titanium or aluminium, or plastic/fibre/carbon material. The basic material is stainless steel or titanium, but other materials can be used, such as synthetic rubber (Viton material) and fluoropolymer elastomers, fibres, carbon or metal gaskets.

The designation “coupling casing” is used as it shall form a fastening against the pipe surface by radially squeezing against the pipe surface.

The material in the coupling casings is dependent on the material in the pipes 10 and 12, respectively, as the inside of the coupling casings shall include grooves, small spikes or cams that shall penetrate into the surface of the pipe and form a fastening that is so strong that the coupling casing shall not be able to begin to glide axially off the pipe. This means that the coupling casings are preferably of a harder material than the pipe.

If the pipes 10,12 shall carry gases and liquids at high pressures and temperatures, such as oil and natural gas, a suitable quality of steel is used for this purpose and the coupling casing is also of a steel quality with a somewhat greater hardness. In addition, said gasket 32 can be inserted between the pipe ends.

If the pipes shall carry other liquids and gases at lower pressures and temperatures, such as water, plastic pipes that can be fibre-reinforced can be used.

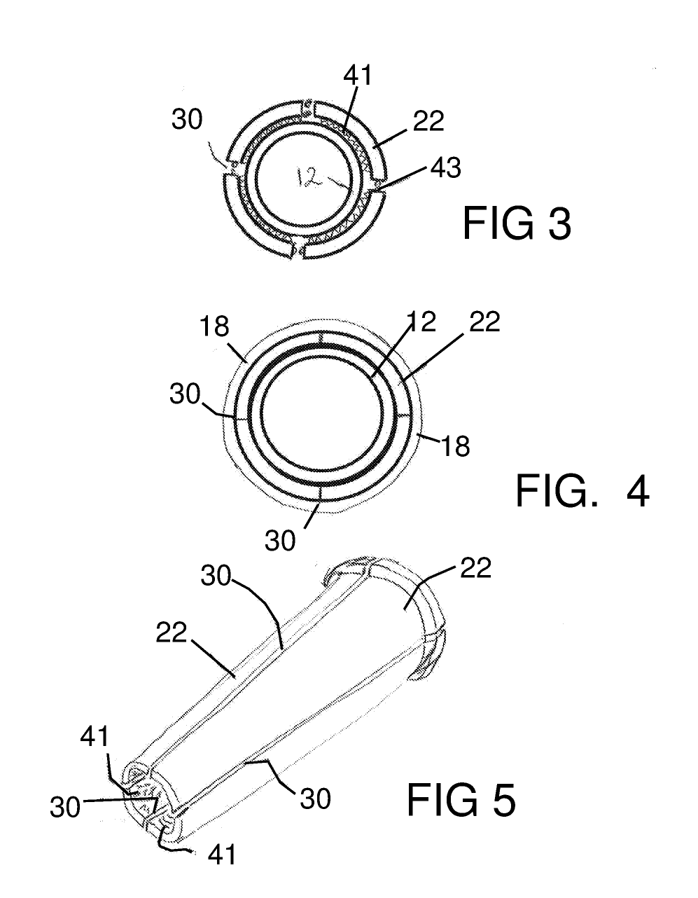

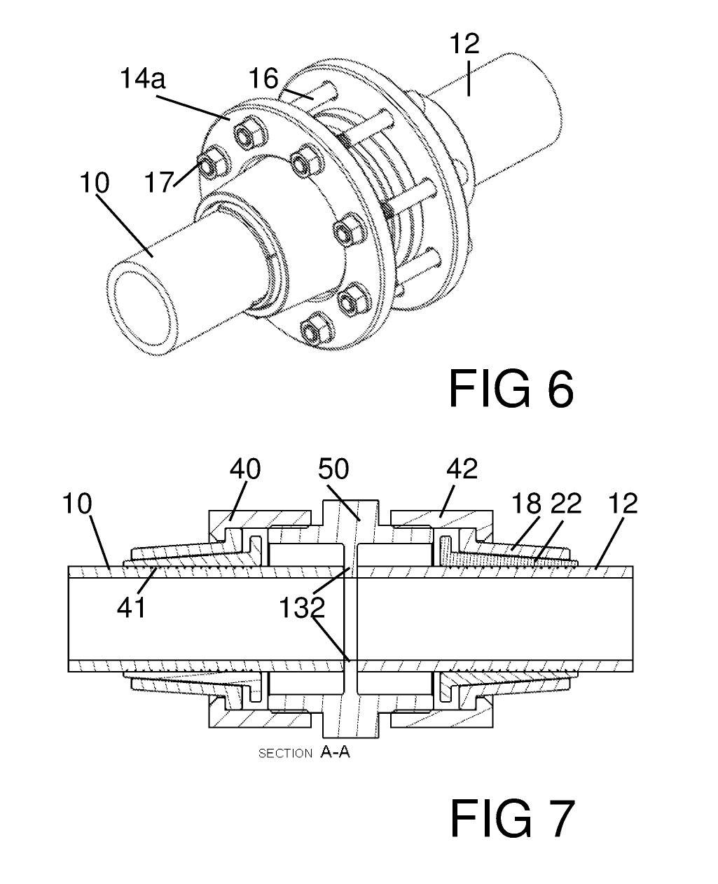

As the material in the coupling casing is not elastic in the same way as a plastic or rubber gasket, but shall still be able to be squeezed against the surface of the pipe to form a fastening against the pipe, it is either formed by assembling separate arch-shaped pieces that have been put together in advance, or it is formed as a whole casing where axial slits have been cut through the pipe walls. When they are placed close together, they define a casing with an approximately same or somewhat smaller diameter than the pipe 10,12, so that they stick to the pipe surface. When they are formed as loose parts, for example, four pieces, they will be placed next to each other so that the gap 30 (FIG. 1) appears as a clear, axially directed slit or groove between the sections. To hold them together with a suitable divide (mutually spaced apart), they are held together by a fastening agent 43 (FIG. 3) such as glue, so that the operator can hold the assembly as a complete unit. When the tightening casing 18 is threaded axially onto and in over the coupling casing, the sections are squeezed together against each other so that the slits/grooves are completely closed and the inside is forced against the pipe surface, as the fastening agent is also squeezed together between the side parts. In FIG. 1 the coupling casing 22 is shown “drawn” as separate, arch-formed part ring discs. Such a slit is shown by 30 and comprises that the coupling casing 22 shown has four such slits 30 around its circumference, as FIG. 1 shows. According to an alternative, the slits can be formed so that they do not cut through the whole of the wall thickness of the casing, but leave a thinner, deformable remaining wall part of the casing. Thereby, the sections are held together as a complete casing during the fitting, while said wall parts are completely squeezed together and are deformed when the casing sections are forced radially inwards towards the outside of the pipe.

In some embodiments, the coupling casing 24 can be formed as a complete pipe-formed body made with axial (longitudinally running) axially-running and through-running grooves that almost go through the pipe wall. When the neck-formed second tightening casing 18 is pushed in over the outside of the coupling casing, this will be pushed and be forced in towards the pipe surface, as said slits are closed under the radially directed force from the outside lying tightening casing 18. Such a slit is shown by 30 and comprises that coupling casing 22 shown has four such slits 30 around its circumference, but can, of course, be formed with more such parallel slits.

The coupling casing 22 has a pure, circular-formed inside adapted to the outer dimensions of the pipe surface. The outer surface of the coupling casing 22 slopes down from the thickest casing wall-diameter 22a at the front casing end (nearest the pipe end), which, in the fitting, is the one end of the coupling casing that is placed adjoining the pipe end, to a thinnest casing wall-diameter 22b at the rear end of the casing 22. This tapering is clearly shown in FIG. 2. Furthermore, the front end 22a of the casing comprises an upwardly extending ring-formed flange 24 around the whole circumference.

A perspective of the coupling casing is shown in FIG. 5, which also shows the sharp grooves and cams 41 on the left in the figure. When the outside-lying neck 18 (outer cylinder) is forced in over/glides over the inner casing 22 later, as shown in FIG. 4, the coupling casing is forced in against the pipe surface and the surface pattern or the grooves/cams/spikes 41 are forced into the surface of the pipe 12 so that the coupling casing is fastened to the pipe end. FIG. 3 shows the four parts of the coupling casing 22 placed enveloping the pipe 12, with the internal grooves or cams 41 that lie in against the surface of the pipe 12.

According to an alternative solution, the inside of the coupling casing, together with said cams, can comprise a rubber gasket layer that squeezes against the pipe surface so that a good seal is achieved, in addition to the cams 41 being forced into the pipe surface.

Furthermore, the two pipe ends squeeze together an in-between lying gasket ring 32 so that one ensures a completely tight coupling between the pipes. The gasket ring can be made from metal, “rubber” (adapted to the medium that runs through the pipes) or a combination of both (metal seal outermost and “rubber” innermost, or the other way around).

Alternatively, the pipe ends can be forced together, metal against metal, and seal without a gasket, something which is possible when the ends of the pipes are appropriately processed and fit together with an acceptable tolerance.

Each tightening casing 18a, 18b has a corresponding conical casing form and a ring-formed, radially outwardly extending flange 20 at its front end. When the tightening casings 18, one from each side, are forced in over their respective coupling casings 22, the conical form will ensure that the coupling casing is forced radially inwards so that the sharp-edged groove pattern “digs into” the pipe surface and stops any further axial displacement of the coupling casing towards the pipe end. Furthermore, the two respective radial flanges work together so that the tightening casing 18 will not only glide over the coupling casing 20, but the tightening flange 20 will lie against the coupling flange 24 which thereby establishes a strong fastening between the two casings, 20 and 18, respectively.

The mutual joining together of the conical coupling and tightening casings 22 and 18, respectively, is provided with the help of the two cooperating rings 14a and 14b, respectively, which are threaded onto the respective pipe ends 25 and 26, respectively, in advance, as illustrated in FIG. 3. When the casing pair is threaded in over its respective pipe end, the rings 14a, 14b are led in over the assembly from the rear and push against the rear side of the flange/shoulder form 20 of the tightening casing and is tightened together with the help of axial bolts 16 which is a well-known technology.

This mutual pushing together of the two casings can also be carried out with screw casings that are mutually put together and screwed together over the casing pair. 18,22.

Internally the screw casings comprise ring-formed barbs that squeeze in against the rear side of the radial shoulder-form 20 of the tightening casing 18.

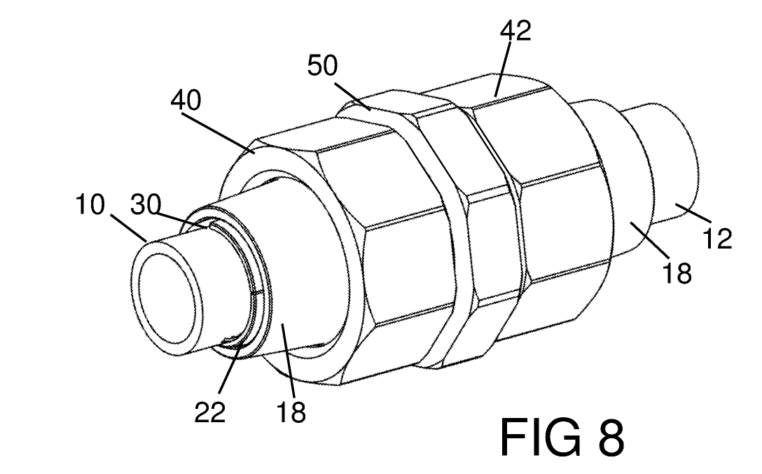

Reference is made to FIG. 7 that shows a corresponding split coupling construction where the two parts are led together axially with the help of threaded casings 40, 42 which are screwed in from separate sides onto the outer threads to a common casing-formed intermediate piece 50. The intermediate piece comprises a sealing ring 132 with an inwardly extending, ring-formed sealing flange 132 that fits into the ring-formed slit between the pipe ends. When the pipe ends 10,12 are screwed together, the tightening flanges are forced together and form a secure seal between the pipes.

Thus, the core of the invention is that two conical casings are squeezed axially against each other so that the inner coupling casing 22, according to the invention, is forced in against the pipe surface and forms a secure fastening with the help of grooves and cams that penetrate into or dig into the pipe surface. Thereby, with the present invention, one can couple together two pipes without the pipe ends needing to be prepared in advance. It might be appropriate to apply some lubrication, such as oil, between the outer side of the coupling casing and the inner side of the tightening casing to ensure minimal friction in the joining together/gliding process.

1. Method for fastening coupling means to respective ends (25,26) of pipes (10,12) that are to be joined together, comprising a pair of mutually axially conical 5 casings (18,22), that can be collapsed into each other, that are inserted on each pipe end, as the conical casing pair is mutually pushed together with the help of respective tightening bodies (14,16) so that the radially outer casing (18) squeezes the inner casing (22) into a fastening against the surface of the pipe (10,12) and joins the pipe ends together, so that a tight joining together is achieved between the ends 10 (25,26) of the pipes (10,12), characterised in that an inner conical casing (22) is used which is divided into a number of sections of axially directed slits (30) through the wall of the casing, said slits (30) contribute to the inner casing being able to be forced radially inwards during the simultaneous closing of the slits (30) and so that the inside of the inner conical casing is forced into a fastening against the surface of 15 the pipe during the mutual pushing together of the casings.

2. Method according to claim 1, characterised in that the respective tightening bodies (14,16), one at each of the rear ends of the two casing pairs (18,22), are led towards each other and fasten the coupling means (18,22) to respective pipe ends, and 20 also join the pipe ends together.

3. (original Method according to claim 1, characterised in that the ends (25,26) of the pipes (10,12) are made to squeeze together an intermediate ring gasket (32) to achieve a secure seal 25.

4. Method according to claim 1 characterised in that an inner conical casing (22) is used, the inside of which comprises means such as sharp-edged grooves, cams or spikes (41) that are squeezed against and into the surface of the pipe in the pushing together and fasten the pair of casings (18,22) to 30 the pipe (10,12).

5. Method according to claim 1, characterised in that an inner casing (22) is used that is divided into four casing sections via a corresponding number of slits (30), as the sections are held together as a complete casing in that a fastening agent (43), such as a glue, has been applied adjoining the edges facing the slits (30) or that the slits do not completely cut through the whole wall thickness of the casing so that the section is held together via a thinner, deformable remaining wall part of the casing.

6. Method according to claim 1 characterised in that a ring formed flange edge (20) (the front of) on the forward end of the outer casing (18) squeezes against the correspondingly ring-formed flange edge (24) (the rear side of) 5 on the forward end of the inner casing (22), as the respective tightening bodies (14,16) are made to lie against said flange edges (24) of the respective outer casings (18) to bring the pipes (10,12) together.

7. Method according to claim 1 characterised in that an inner casing of metal, such as stainless steel or titanium, or a plastic material, fibre reinforced plastic material or a composite material containing carbon fibres, such as an epoxy-based reinforced material, is used.

8. Construction of a pipe end for use in the coupling together of two pipes (10,12), comprising a set of inner and outer mutually axially conical casings (18,22) that can be collapsed into each other for insertion onto the respective pipe ends, where the inner casing (22) comprises means to form a fastening in and against the surface when it is squeezed radially against the pipe end as a consequence of a mutual axially pushing together of the two casings (18,22), characterised in that the inner conical casing (22) is divided into a number of sections by axially directed slits (30) through the wall of the casing, said slits (30) contribute to the inner casing being able to be forced radially inwards during the simultaneous closing of the slits (30), and so that the inside of the inner conical casing is forced into a fastening against the surface of the pipe during the mutual pushing together of the casings.

9. Construction according to claim 8, characterised in that the separate sections with axially directed slits (30) through the wall of the casing are held together as a complete casing in that a fastening agent (43), such as a glue, is applied in adjoining edge surfaces facing the slits (30) or that the slits do not completely cut through the whole of the wall thickness of the casing so that the section is held together via a thinner, remaining part of the wall of the casing.

10. Construction according to claim 8, characterised in that the inner surface of the inner conical casing (22) comprises fastening means in the form of sharp-edged grooves, cams or spikes (41) set up to be squeezed into the surface of the pipe.

11. Construction according to claim 8 characterised in that the inner surface of the casing (22) comprises a sealing layer and also said sharp-edged grooves, cams and spikes (41), as the sealing layer is brought to squeeze against the surface of the pipe simultaneously with the sharp grooves, cams or spikes (41) 5 being forced into the pipe.

12. Construction according to claim 8 characterised in that the casing (22) that is divided into four casing sections via a number of corresponding slits (30) which are joined together with a fastening agent.

13. Construction according to claim 8 characterised in that the respective forward ends of the casings comprise flange edges (20 and 24, respectively) that are brought to lie against each other when the casings are pushed together for fastening to the end of the pipe.

14. Construction according to claim 8 characterised in that an inner casing of metal, such as stainless steel or titanium, or a plastic material, or a composite material containing carbon fibres, such as an epoxy-based carbon fibre reinforced material, is used.

15. (canceled)
